(19) United States
(12) Patent Application Publication
(10) Pub. No.: US 2026/0359587 A1
(43) Pub. Date: Nov. 12, 2026

(54) SYSTEM USING RFID TECHNOLOGY FOR INVENTORYING OBJECTS IN A SPACE DELIMITED BY AN ENCLOSURE

(71) Applicant: NEXESS, Valbonne-Sophia Antipolis (FR)

(72) Inventors: Anh Tu HO, Valbonne-Sophia Antipolis (FR); Jean-Anaël MONBLANC, Valbonne-Sophia Antipolis (FR)

(73) Assignee: NEXESS, Valbonne-Sophia Antipolis (FR)

(21) Appl. No.: 19/153,542

(22) PCT Filed: Jan. 25, 2024
(86) PCT No.: PCT/EP2024/051769

§ 371 Date: Aug. 4, 2025

(30) Foreign Application Priority Data
Feb. 2, 2023 (FR) FR2300991

(51) Int. Cl. G06K 7/10; G06K 19/07; G06K 19/077; G06Q 10/087

(52) U.S. Cl. CPC G06K 7/10346; G06K 19/0723; G06K 19/07786; G06Q 10/08772

(57) ABSTRACT

A system for inventorying objects in a closed space delimited by an enclosure. The system includes a control device connected to a UHF RFID reader disposed in the closed space, the UHF RFID reader being provided with at least one antenna that sends electromagnetic waves to RFID tags disposed on the objects, the objects each having a predetermined position in the closed space. According to the invention, at least some of the predetermined positions include an auxiliary electromagnetic-wave radiating element.

### TECHNICAL FIELD

The present invention relates to a system using RFID technology for inventorying objects in a space delimited by an enclosure.

### PRIOR ART

Systems for inventorying objects in a delimited space using RFID technology are known. In general terms, a system using RFID technology consists of three types of element:
at least one transponder, also referred to as a tag, consisting of an electronic circuit provided with an antenna for sending and receiving data in the form of radio-frequency waves, the circuit comprising at least one memory in which an identifier of said transponder is stored,
a reading point also consisting of an electronic circuit provided with an antenna for sending and receiving data also in the form of radio-frequency waves, and
a control unit connected to the reading point and implementing an application.

The operation of such an RFID system is as follows. At the commencement of the identification procedure, the reading point sends a modulated electromagnetic wave, referred to hereinafter as a wake-up wave, to each tag in the system. On reception thereof, a tag, located in a coverage area where the electromagnetic field generated by the reading point is at a sufficiently high level, is electrically supplied by the electromagnetic wave, emerges from its standby state, becomes active and then sends identification data that is particular to it in the form of a modulated electromagnetic wave. This identification data is received by the reading point, which then proceeds with identifying the tag in question.

In the application to an inventory system envisaged here, each tag is secured to an object, such as a tool used for maintaining a workshop, a factory, etc. The objects to be inventoried are stored in a closed space, such as a cabinet, a bench or a cupboard. Each closed space is subdivided into a plurality of closed subspaces such as for example shelves, drawers, etc.

Several technological developments have appeared during the past years for making RFID technology more effective and more discreet. Tags have been miniaturised, the configuration of the tag antennas has been modified to be able to be used on metal objects or surfaces such as plastics material or rubber, and the sensitivity of RFID readers has been improved.

RFID tags thus at the present time have a size not exceeding 40 mm³ and have miniature antennas that lead to a significant drop in gain thereof.

It is therefore difficult to detect objects having RFID tags in closed enclosures having a large volume.

### DISCLOSURE OF THE INVENTION

For this purpose, the invention relates to a system for inventorying objects contained in a closed space delimited by an enclosure, the system comprising a control device connected to a UHF RFID reader disposed in the closed space, the UHF RFID reader being provided with at least one antenna that sends electromagnetic waves to RFID tags disposed on the objects, the objects each having a predetermined position in the closed space, characterised in that at least some of the predetermined positions comprise an auxiliary electromagnetic-wave radiating element; wherein the auxiliary radiating element consists of two trapezoidal-shaped arms and two load bars each comprising a notch separating the load bar into two distinct parts.

Thus the present invention reinforces the electromagnetic fields around the tagged metal objects, leading to an improvement in the detection of the object. Furthermore, the invention, by using auxiliary radiating elements, offers a possibility of adapting the design according to requirements and ease of implementation.

Thus the invention improves the rate of detection of the tagged object in a closed metal space. The pattern proposed affords more flexibility in positioning the object while having performances less sensitive to the angular direction of the tag, and in optimising the antenna.

According to a particular embodiment, a trapezoidal-shaped arm comprises three recesses disposed on the largest side of the trapezoidal shape.

Thus the present invention, having an asymmetric shape, aims to widen the range of operation of the solution in the ETSI and FCC bands while having a wide band or multi-bands. Furthermore, the solution will also make it possible to reduce the size of the auxiliary radiating element.

According to a particular embodiment, one trapezoidal-shaped arm comprises two recesses, each recess being respectively on one side of the trapezoidal shape.

Thus the present invention, having an asymmetric shape, aims to widen the range of operation of the solution in the ETSI and FCC bands while having a wide band or multi-bands. Furthermore, the solution will also make it possible to reduce the size of the auxiliary radiating element.

### BRIEF DESCRIPTION OF THE DRAWINGS

The features of the invention mentioned above, as well as others, will emerge more clearly from the reading of the following description of example embodiments, said description being made in relation to the accompanying drawings, among which:

FIG. 1 is a schematic view of an inventory system of a bench in which the present invention is implemented;

FIG. 2 is an example of architecture of the inventory system according to the present invention;

FIG. 3 illustrates the operating principle of the improved system for inventorying objects contained in a delimited space using the RFID technology according to the present invention;

FIG. 4 is a first example embodiment of the improved system for inventorying objects contained in a delimited space using the RFID technology according to the present invention;

FIG. 5 is a second example embodiment of the improved system for inventorying objects contained in a delimited space using the RFID technology according to the present invention;

FIG. 6 is a first example embodiment of an auxiliary electromagnetic-wave radiating element used in the improved system for inventorying objects contained in a delimited space using the RFID technology according to the present invention;

FIG. 7 is a second example embodiment of an auxiliary electromagnetic-wave radiating element used in the improved system for inventorying objects contained in a delimited space using the RFID technology according to the present invention;

FIG. 8 is a third example embodiment of an auxiliary electromagnetic-wave radiating element used in the improved system for inventorying objects contained in a delimited space using the RFID technology according to the present invention.

### DETAILED DISCLOSURE OF EMBODIMENTS

FIG. 1 is a schematic view of an inventory system according to a first embodiment of the present invention.

The inventory system shown in FIG. 1 is designed for inventorying objects that are contained in a closed space such as a cabinet 10, a cupboard or a bench in a workshop, which can contain elements such as shelves or drawers Tir forming closed subspaces. This closed space and these closed subspaces are respectively delimited by a metal enclosure.

The objects in question are for example tools for maintaining a workshop, a factory, etc. These objects are provided with an RFID (Radio Frequency IDentification) tag.

The inventory system comprises a control device 100.

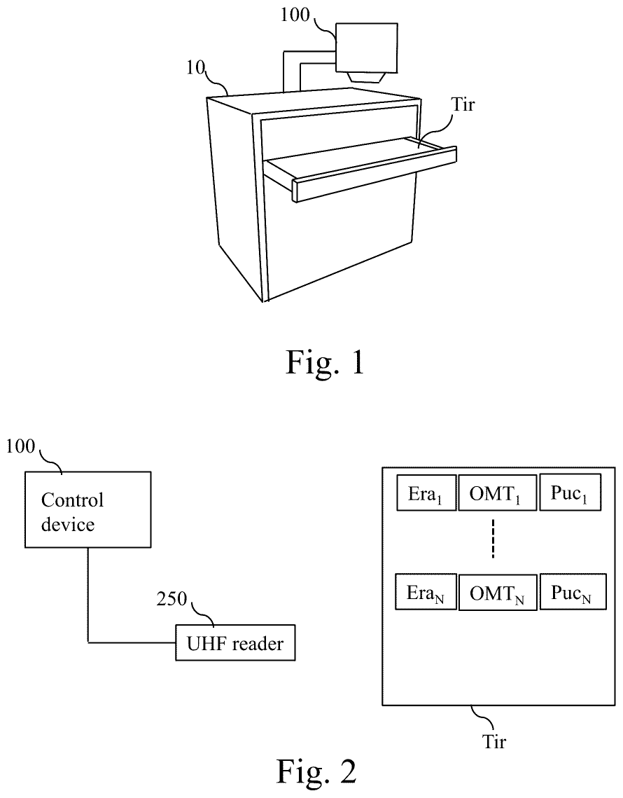

FIG. 2 is an example of architecture of the inventory system according to the present invention.

The control device 100 is connected to a UHF RFID reader 250 disposed in the closed space 10. The UHF RFID reader 250 is provided with at least one antenna, not shown, which sends electromagnetic waves to RFID tags. The control device 100 is, for example, a computer, a smartphone or a touchscreen tablet.

The objects contained in the closed space each have a predetermined position, thus enabling the control device to determine or not whether each object is present in the closed space.

At least some of the predetermined positions comprise an auxiliary electromagnetic-wave radiating element according to the invention.

For example, in the drawer Tir, at the predetermined positions of the objects OMT₁ to OMT_{N} comprising a tag Puc₁ to Puc_{N}, the auxiliary radiating elements Era₁ to Era_{N} are disposed.

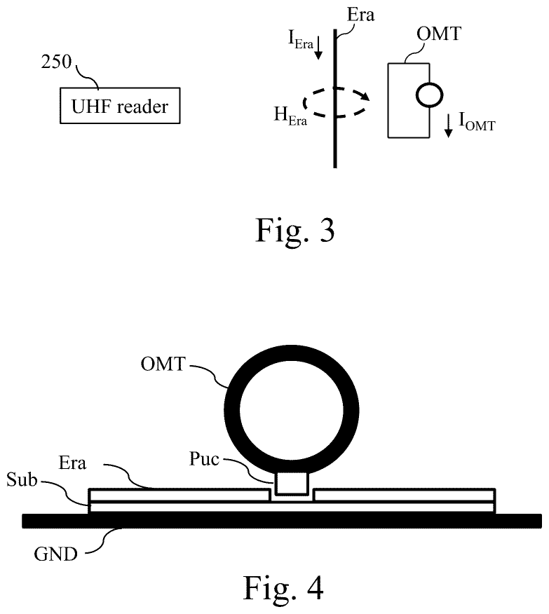

FIG. 3 illustrates the operating principle of the improved system for inventorying objects contained in a delimited space using the RFID technology according to the present invention.

The UHF RFID reader 250 is provided with at least one antenna, not shown, which sends electromagnetic waves to RFID tags. The electromagnetic waves are received by the auxiliary radiating element Era. When the auxiliary radiating element Era receives energy in the form of electromagnetic waves, the energy induces a current I_{Era} that generates an intense magnetic field H_{Era}. The presence of the object OMT comprising an RFID tag in the intense magnetic field introduces an inductive current I_{OMT} inside the object, which supplies the RFID tag.

The higher the density of the magnetic field H_{Era}, the greater the power received by the RFID tag. The signal received by the RFID tag is reinforced, therefore involving an increase in the reading range of the UHF RFID reader 250.

FIG. 4 is a first example embodiment of the improved system for inventorying objects contained in a delimited space using the RFID technology according to the present invention.

In the example in FIG. 4, a predetermined position comprises an auxiliary radiating element Era according to the invention.

The auxiliary radiating element Era is disposed on a substrate, for example of the FR4 type, with a thickness of 1.6 mm, resting on an earth plane GND.

The object OMT comprising an RFID tag Puc is disposed above the auxiliary radiating element Era.

In FIG. 4, the RFID tag Puc is disposed facing the auxiliary radiating element Era.

Depending on the form of the auxiliary radiating element Era, the RFID tag Puc can be disposed in a different orientation, thus making it possible to dispose the object OMT in any orientation, provided that the object is placed above the auxiliary radiating element.

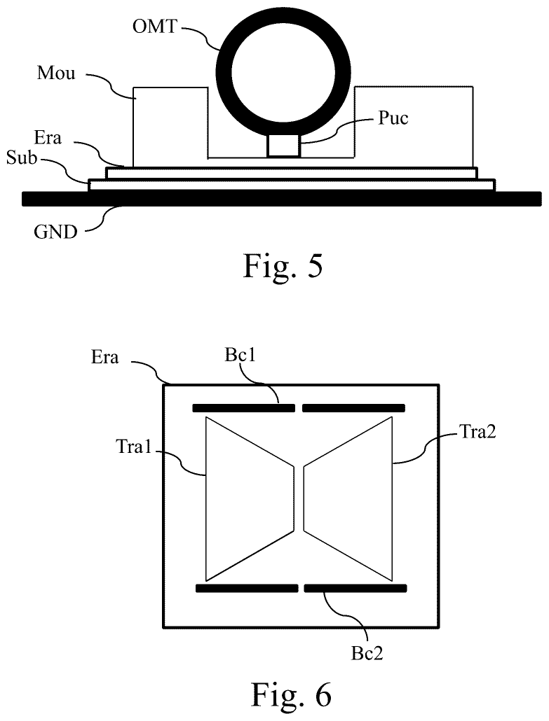

FIG. 5 is a second example embodiment of the improved system for inventorying objects contained in a delimited space using the RFID technology according to the present invention.

In the example in FIG. 5, a predetermined position comprises an auxiliary radiating element Era according to the invention.

The auxiliary radiating element Era is disposed on a substrate Sub resting on an earth plane GND.

The object OMT comprising an RFID tag Puc is disposed above the auxiliary radiating element Era.

In order to ensure correct positioning of the object OMT comprising an RFID tag, a foam, conformed to be adapted to the shape of the object OMT intended to be placed at the predetermined position, is disposed above the auxiliary radiating element Era.

The foam consists of a material permeable to electromagnetic waves, for example made from polyurethane. This material has a permittivity of 1.03 to 1.21 for the frequency band below 10 GHz. Thus the foam is completely transparent to the propagation of electromagnetic waves.

In FIG. 5, the RFID tag Puc is disposed facing the auxiliary radiating element Era.

Depending on the form of the auxiliary radiating element Era, the RFID tag Puc can be disposed in a different orientation, thus making it possible to dispose the object OMT in any orientation, provided that the object is placed above the auxiliary radiating element.

FIG. 6 is a first example embodiment of an auxiliary electromagnetic-wave radiating element used in the improved system for inventorying objects contained in a delimited space using the RFID technology according to the present invention.

The auxiliary radiating element Era consists of two trapezoidal-shaped arms Tra1 and Tra2 and two load bars Bc1 and Bc2 each comprising a notch separating the load bar into two distinct parts. The length of the two bars Bc1 and Bc2 and the width of the notch are 52 mm and 0.4 mm respectively. The width of the bars is measured at 2 mm. The configuration proposed makes it possible to optimise the radiating structure, which gives an improvement in detection of the tagged objects in various directions.

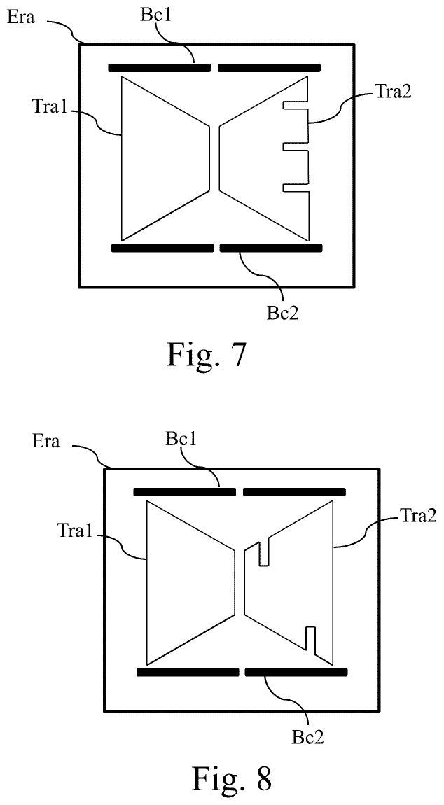

FIG. 7 is a second example embodiment of an auxiliary electromagnetic-wave radiating element used in the improved system for inventorying objects contained in a delimited space using the RFID technology according to the present invention.

The auxiliary radiating element Era consists of two trapezoidal-shaped arms Tra1 and Tra2 and two load bars Bc1 and Bc2 each comprising a notch separating the load bar into two distinct parts. In the example in FIG. 7, the trapezoidal-shaped arm Tra2 comprises three recesses or slots disposed on the largest side of the trapezoidal shape. These recesses or slots make it possible to adjust the bandwidth of the auxiliary radiating element Era.

FIG. 8 is a third example embodiment of an auxiliary electromagnetic-wave radiating element used in the improved system for inventorying objects contained in a delimited space using the RFID technology according to the present invention.

The auxiliary radiating element Era consists of two trapezoidal-shaped arms Tra1 and Tra2 and two load bars Bc1 and Bc2 each comprising a notch separating the load bar into two distinct parts. In the example in FIG. 8, the trapezoidal-shaped arm Tra2 comprises two recesses or slots, each recess or slot being respectively on one side of the trapezoidal shape. These recesses or slots make it possible to adjust the bandwidth of the auxiliary radiating element Era.

1. A system for inventorying objects contained in a closed space delimited by an enclosure, the system comprising a control device connected to a UHF RFID reader disposed in the closed space, the UHF RFID reader being provided with at least one antenna that sends electromagnetic waves to RFID tags disposed on the objects, the objects being intended to be placed respectively at a predetermined position in the closed space, at least some of the predetermined positions comprising an auxiliary electromagnetic-wave radiating element, wherein the auxiliary radiating element consists of two trapezoidal-shaped arms and two load bars each comprising a notch separating the load bar into two distinct parts.

2. The system according to claim 1, wherein a trapezoidal-shaped arm comprises three recesses or slots disposed on the largest side of the trapezoidal shape.

3. The system according to claim 1, wherein a trapezoidal-shaped arm comprises two slots, each slot being respectively on one side of the trapezoidal shape.
